(19) United States
(12) Patent Application Publication
(10) Pub. No.: US 2014/0183212 A1
(43) Pub. Date: Jul. 3, 2014

(54) VENDING MACHINE WITH TEMPERATURE-CONTROL DEVICE

(71) Applicants: HON HAI PRECISION INDUSTRY CO., LTD., New Taipei (TW); HONG FU JIN PRECISION INDUSTRY (WUHAN) CO., LTD., WUHAN (CN)

(72) Inventors: JIAN ZHAO, Wuhan (CN); CHONG HE, Wuhan (CN); XIAO-HUI WANG, Wuhan (CN); WEN-JUN HU, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/010,144

(22) Filed: Aug. 26, 2013

(30) Foreign Application Priority Data
Dec. 27, 2012 (CN) 2012105777578

(51) Int. Cl. G07F 9/10

(52) U.S. Cl. CPC G07F 9/105
USPC 221/150 R

(57) ABSTRACT

A vending machine in which the internal temperature can be locally and remotely controlled and set includes an input device, a temperature control device, and a main control board. The input device inputs a temperature value. The main control board includes a control module, a setting module, and a storing module. The setting module receives and sets the temperature value. The control module controls the temperature control module to adjust temperature of the vending machine according to the set temperature.

### BACKGROUND

1. Technical Field

The present disclosure relates to vending machines, more particularly to a vending machine with a temperature-control device.

2. Description of Related Art

Vending machines allow customers to buy product twenty fours a day. A vending machine may include a temperature control device. However, the temperature control device must be manually operated to adjust the temperature of the vending machine, which is wasteful of time and labor.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of a vending machine in accordance with an embodiment.

FIG. 2 is another block diagram of a vending machine in accordance with an embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

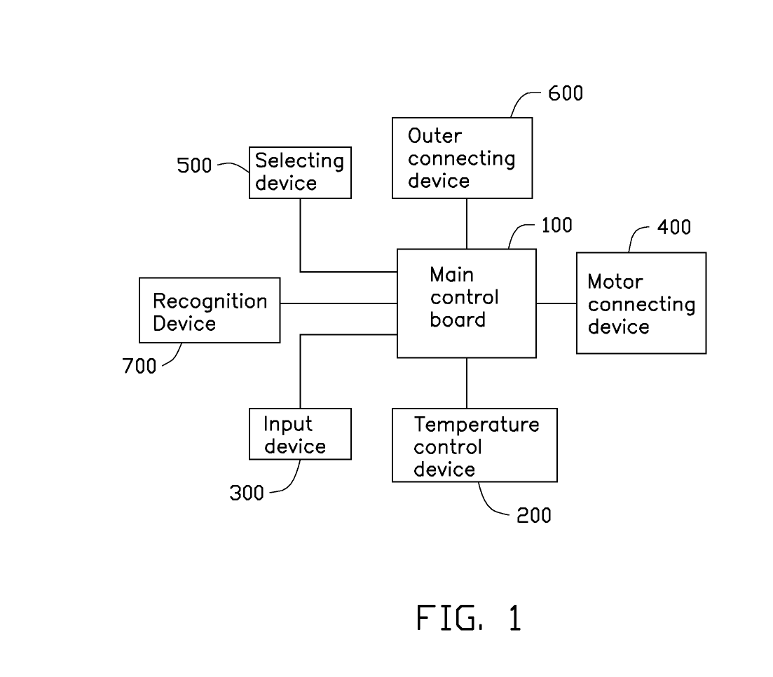

FIG. 1 illustrates a vending machine in accordance with an embodiment. The vending machine includes a main control board 100, a temperature control device 200, an input device 300, a motor connecting device 400, a selecting device 500, an outer connecting device 600, and a recognition device 700.

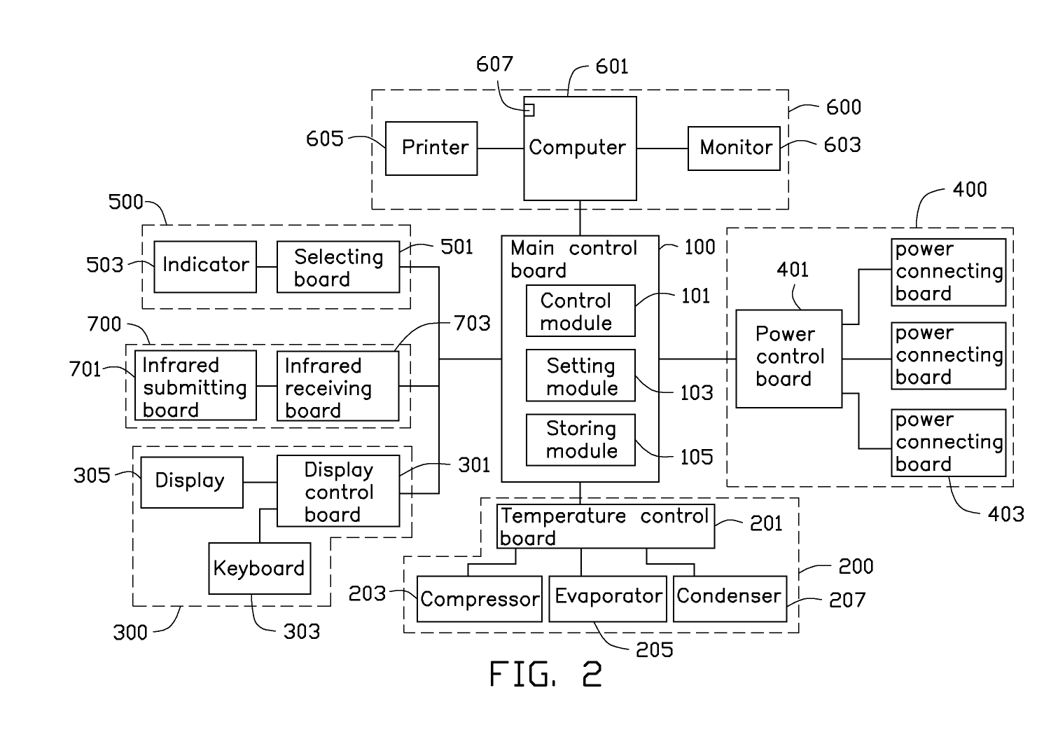

FIG. 2 shows that the temperature control device 200 includes a temperature control board 201 connected to the main control board 100, a compressor 203 connected to the temperature control board 201, an evaporator 205, and a condenser 207.

The input device 300 includes a display control board 301 electronically connected to the main control board 100, a keyboard 303 electronically connected to the display control board 301, and a display 305 electronically connected to the display control board 301. The display control board 301 is electronically connected to the main control board 100 via an RS-485 bus. The keyboard allows vendor to input and set values, such as temperature value. The display 305 is used for displaying the temperature value.

The motor connecting device 400 includes a power control board 401 electronically connected to the main control board 100 and a plurality of power connecting boards 403 electronically connected to the power control board 401. The power connecting boards 403 are electronically connected to motors (not shown). The motors drive access and output openings (not shown).

The selecting device 500 includes a selecting board 501 and a plurality of indicators 503 mounted to the selecting board 501. The selecting board 501 is electronically connected to the main control board 100. The selecting board 501 is connected to the main control board 100 via an RS-485 bus. The selecting board 501 receives signals when a customer presses buttons and delivers the signals to the main control board 100.

The outer connecting device 600 includes a computer 601 electronically connected to the main control board 100, a monitor 603 electronically connected to the computer 601, a printer 605 electronically connected to the computer 601, and a network interface 607.

The recognition device 700 includes an infrared submitting board 701 and an infrared receiving board 703 connected to the infrared submitting board 701. The infrared receiving board 703 is electronically connected to the main control board 100 via an RS-485 bus. The recognition device 700 detects the proper drop of a bought item after the payment of money and item selection.

The main control board 100 includes a control module 101, a setting module 103, and a storing module 105.

The setting module 103 receives a temperature value inputted through the keyboard 303. The storing module 105 stores the temperature value. The control module 101 controls the temperature control device 200 to adjust the temperature. The computer 601 is connected to the remote device (not shown) via the network interface 607. A control command to the temperature control device 200 to adjust the temperature can be sent by the remote device.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A vending machine comprising:
an input device, the input device is configured to input a temperature setting value;
a temperature control device, the temperature control device is configured to adjust temperature in the vending machine; and
a main control board, the main control board comprises a control module, a setting module, and a storing module; the setting module is configured to receive the temperature setting value; and the control module is configured to control the temperature control device to adjust temperature in the vending machine according to the temperature setting value.

2. The vending machine of claim 1, wherein the input device comprises a keyboard and a display; the keyboard is configured to input the temperature setting value; and the display is configured to display the temperature setting value.

3. The vending machine of claim 2, wherein the input device further comprises a display control board electronically connected to the keyboard and the display, and the display control board is electronically connected to the main control board.

4. The vending machine of claim 1, wherein the temperature control device comprises a compressor, an evaporator, and a condenser.

5. The vending machine of claim 4, wherein the temperature control device further comprises a temperature control board electronically connected to the compressor, the evaporator, and the condenser; and the temperature control board is electronically connected to the main control board.

6. The vending machine of claim 1, further comprising a computer electronically connected to the main control board; wherein the computer comprises a network interface configured to be connected to a remote device, and the temperature control device is further configured to receive a control command from the remote device to adjust temperature.

7. The vending machine of claim 1, further comprising a selecting device, wherein the selecting device comprises a selecting board electronically connected to the main control board and an indicator electronically connected to the selecting board.

8. The vending machine of claim 7, wherein the selecting board is electronically connected to the main control board via an RS-485 bus.
